(19) United States
(12) Patent Application Publication
(10) Pub. No.: US 2017/0232883 A1
(43) Pub. Date: Aug. 17, 2017

(54) ACCESSORY FOR VEHICLES FOR AUTOMATING MAIN BEAMS COMPLETE WITH AN ELECTRONIC SYSTEM FOR REDUCING OPTICAL DISTURBANCES

(71) Applicant: Nice S.r.l., Roma (IT)

(72) Inventors: Oleksandra Dzyubyk, Orvieto (TR) (IT); Sergio Polverini, Orvieto (TR) (IT)

(73) Assignee: Nice S.r.l., Roma (IT)

(21) Appl. No.: 15/314,125

(22) PCT Filed: May 27, 2015
(86) PCT No.: PCT/IB2015/053980

§ 371 Date: Nov. 28, 2016

(30) Foreign Application Priority Data
May 28, 2014 (IT) FI2014A000129

(51) Int. Cl. B60Q 1/14

(52) U.S. Cl. CPC B60Q 1/1423; B60Q 2300/314; B60Q 2300/45; B60Q 2900/30; B60Q 2300/42

(57) ABSTRACT

The electronic device described in the present patent application applies to the accessories used to automate the main beams that use sensors to detect the light coming from the vehicles met along roads. The device reduces or even suppresses the undesired effects produced by reflections, onto the surrounding objects, of the lights of the vehicle on which it is mounted, thus avoiding undesired main beam turn-off signals. Said device is particularly convenient to use if mounted after the vehicle is commissioned, being it compatible with wireless transmission systems which make its installation easier.

### TITLE

Accessory for vehicles for automating main beams complete with an electronic device for reducing optical disturbances.

### TECHNICAL FIELD

The present invention belongs to the sector of the universal accessories for road vehicles, in particular those accessories which can be easily installed on any already manufactured vehicles.

Specifically, its field of application concerns those devices which automate the turning-off of the main beams of a vehicle whenever this one meets another vehicle, its own main beams being turned-on, and cause their subsequent turning-on again.

### PRESENT STATUS OF THE ART

The accessories used to automatically control the turning of the main beams of vehicles on and off exploit the signal coming from an optical detector which receives the photo-luminiscent signal emitted by the full beam headlights of the vehicles that are met.

Whenever the sensor receives a light beam, a main beam turn off mechanism is activated, without any driver's intervention, and the headlights will be turned on again after meeting the vehicle, upon disappearance of the signal emitted by the headlights of the latter.

However, other light sources are present on the road besides that of the vehicles that are met and these might disturb the operation of the device.

Some of these problems have been dealt with in patent application FI2013A000072 which, however, does not solve the problem of reflection of the light beam emitted by the same vehicle on which the device is installed onto the objects present along the road; as a matter of fact said light beam is reflected by the reflecting road signs and this reflection might cause the full beam headlight to unduly automatically turn off.

As a matter of fact, the known devices do not discriminate the reflected light from that emitted by the headlights of a vehicle that runs on the same road in the opposite direction, in that the reflected light intensity is comparable to the intensity of the light emitted by a vehicle that is approximately 300 meters far away and whose dipped headlights are turned on, i.e. in a condition whereby the automatic turn off device is driven into operation.

The device having been triggered results in limiting night visibility, a circumstance that often leads drivers to deactivating it. The disturbance caused by the surrounding objects can be easily removed in devices like those described in patent applications EP 2127944 A1, DE 10156649 A1 and DE 102007026750 A1, which take advantage of computerized systems that manage and analyze images collected via cameras.

Conversely, more complex is solving this problem in the case of less expensive accessories not provided with cameras, whose operation is based on the electrical signal received from one or several sensors. In general, the known systems perform a comparison between the light beam incident in the sensor and produced by exogenous sources and that produced by the vehicle in combination with these sources. A similar approach is used in the device described in patent application GB 2464019 A, so as to prevent dazzling in the case of surfaces located in front or at the back of the vehicle.

Further, patent application U.S. Pat. No. 5,329,206 A discloses a device that comprises electronic means that modify the frequency of the light beam produced by the vehicle so as to discriminate the sources of the light detected by sensors. A device like this can be easily integrated in the case of installation on mass-produced vehicles, even though the modulating circuit results in higher costs. Conversely, its application is critical for accessories to be installed after commissioning the vehicle, which must undergo greater limitations, like those described in patent application EP 0533508 A2.

Among these, let's mention the need for preventing the vehicle from being wired, and the consequent adoption of a wireless signal transmit assembly, whereby the sensor and the transmission assembly shall be powered independently, for instance by a battery.

An accessory for already commissioned vehicles using wireless signal transmission is described in DE 102009005571 A1. This accessory makes it possible an automatic turn on and off of the full beam headlights, but this patent application does not take into account the energy and maintenance issues of the device, as widely described in said patent application ITFI20130072 A1.

For those applications which are installed after commissioning the vehicle, account shall be taken not only of costs, but also of the power consumption and circuit complexity of the light sensor that interacts with the circuit that controls the turning on and off of the main beams. As a matter of fact, battery's consumption and manufacturing costs are key factors.

Another aspect that makes it difficult to automate the full beam turn on and off operations depends on the difficulty in identifying for certain the red back lights of the preceding vehicles whenever these are particularly weak. As a matter of fact characteristics of the back lights of vehicles, even though specified by the international road traffic standards for what concerns color and position, are often poor from the emitted intensity point of view, also because of the optical assembly got old and of the reflecting layer present on the parabola having oxidized.

A detection at a suitable distance, the latter considered to range from 100 to 150 meters, is conditional on a visible radiation capturing technique featuring an extreme sensitivity and selectivity, because the luminous intensity of tail lights is small as referred to the distance at which it is necessary to detect it; consequently high-sensitivity optical detection systems shall be used.

Whilst high sensitivity optical detection circuits are suitable for capturing the target luminous energy, even when this is less than 0.1 lux, on the other hand they are still subjected to the disturbances coming from interfering light sources, for instance from the diffused artificial lighting present in the visible sphere and in the road shoulders, or even from the lighting projected by the advancing vehicle projected the carriageway.

### PURPOSES AND SUMMARY OF THE INVENTION

The accessory complete with an electronic device for deleting optical disturbances according to the present patent application effectively solves the problems resulting from its use in environments in which external, even reflecting objects are present, in a simple and cost-effective manner. Specifically, the subject device reduces power consumption and makes the use and installation of the accessory simpler, while guaranteeing a substantial reduction of undesired turnings off.

Such purposes are achieved by integrating a first innovative electronic circuit in the full beam headlight turn on and off control circuit, also called relay circuit, and by integrating a second innovative circuit in the sensor circuit.

As a matter of fact, it is known that the automatic full beam headlight turn off accessories comprise a sensor circuit and a relay circuit which can be advantageously connected to each other by a wireless link, for instance a radio link.

The device according to the present patent application reproduces the same full beam headlight turn off and on sequence in both circuits, while simultaneously checking for the presence of residual light at the headlight turn off times, so as to perceive the presence of reflections due to surrounding objects, which would otherwise cause undesired and particularly irritating turnings off.

The electronic noise deletion device modifies the conventional behavior of the accessory by introducing predetermined headlight turn off and on sequences as soon as the sensor detects a turn off condition. Said sequences make it possible to get more information through the already existing sensor. Advantageously are such instructions incorporated in the circuits nor they require any processing, like those necessary in the case of images acquired by cameras.

This feature makes the device extremely simple and results in reduced electrical power consumptions, thus solving a specific technical problem present in the current status of the art.

Conveniently can these instructions be directly integrated in the electronic component. In a preferred embodiment said instructions are managed by central processing units that benefit by integrated, dedicated programs or softwares: the firmware related to the sensor circuit and another firmware related to the control circuit. Advantageously can the accessory comprise two microcontrollers that integrate the instructions directly in their own internal storage.

The main beam control circuit comprises a wireless receive assembly which transmits a data stream to the central processing unit, which outputs headlight turn on and off controls, by using an electronic switch of a known type, for instance one based on the use of a power transistor.

The photo-detector circuit comprises, downstream the light detector sensor and its respective decision circuit, a central processing unit which sends the signal to a wireless transmit assembly and a coincidence comparator which is driven by the same central processing unit. If necessary, an equalizer filter can be equipped to suppress some components in the signal input to the coincidence comparator.

Whenever a full beam headlight turn off condition occurs, the conventional decision circuit sets the central processing unit, which sends a turn off signal to the control circuit according to a predetermined sequence and activates a comparison on the basis of that sequence. The comparator checks whether a relative dark is present during such sequence and, should this check be successful, the central processing unit includes in the transmitted signal a reflection or blank which, upon reaching the control circuit, causes the headlights to turn on again.

So, the electronic circuit according to the present patent application makes it possible to limit the duration of the undesired turn off just to the period of the predetermined sequence. Not counting that the headlights are not always off during the sequence.

Purely as an indication, in an accessory like that described above, the transmitter is the element featuring the greatest power consumption, followed by the central processing unit, the decision circuit, and the day/night activation circuit, if any. Advantageously is the operating mode of the accessory such as to activate the elements featuring the highest power consumptions, not connected to the vehicle's battery, only when strictly necessary, thus substantially reducing the frequency of replacement of the battery dedicated to the sensor circuit.

In particular, the sensor circuit can be activated by a very-low-power-consumption crepuscular sensor, or the like.

Then in reduced power consumption conditions, the decision circuit only triggers the operation of the central processing unit when so really requested by the operating conditions, usually whenever the signal generated by the photo-detectors exceeds a predetermined threshold level.

Finally, the electronic disturbance reduction or deletion system makes it possible to limit data transmissions, also in the form of pauses which prevent checks from being continually made within the predetermined time intervals.

For instance, considering the time elapsing before meeting a vehicle, the check for the presence of a light beam from another vehicle can be repeated every second. Advantageously, this solution also reduces the reduced lighting period.

A further advantage achieved by the present invention relates to its ability to accurately and remotely identify the red tail lights of the vehicles that precede that on which the accessory according to the present patent application is mounted.

The power level of the light energy emitted by the tail lights of the preceding vehicles is detected by sensors, for instance photodiodes, which are capable of converting a light wave into an electrical signal, but do not have the selective capability necessary for wave length (λ) discrimination.

The sensors, or photodiodes, normally used in these applications, for instance the photovoltaic ones, emit an electric signal proportional to the quantity of light they are exposed to, but they do not discriminate its color. The light emissions from the red tail lights are comprised in the visible spectrum and feature wavelengths that are measured in nanometers (nm).

The artificial light, which is either white or yellow, comprises a visible spectrum comprising wavelengths from 400 to 700 nm; consequently the luminous energy is spread over a bandwidth of approximately 300 nm.

The luminous energy corresponding to the red tone is concentrated in the band from 620 to 700 nm, corresponding to a bandwidth of approximately 80 nm.

The invention according to the present patent application, on a dedicated photo-detector, adopts special optical filters that select the luminous energy close to the wavelength corresponding to the red color, while rejecting the remaining color tones of the light. Surprisingly, thanks to the use of this optical filter, integrated in the lens-based light beam concentration system that is normally used in this type of devices, it becomes possible to accurately and remotely detect the presence of the tail lights of vehicles, even when their luminous intensity is not particularly high.

Thanks to the insertion of a high-sensitivity sensor, also referred to as red sensor, dedicated to detecting said 660 nm±40 nm wide spectrum corresponding to the red tone, it is possible to enhance the sensitivity of the accessory according to the present patent application, thus substantially improving the detection of the red tail lights of the preceding vehicles.

An optical filter, installed upstream the red sensor, is used to make the radiations corresponding to the red tone only pass through whilst rejecting the others, present in the artificial light sources featuring colors close to white, thus enhancing the selective sensitivity of the red sensor.

The signal detected by the red sensor is sent to the decision circuit together with the signal detected by the main light sensor, hence both sensors are in a position to trigger, one independently of the other, the transmission procedure to the receive assembly, which in turn drives the main beams electronic switches.

### BRIEF DESCRIPTION OF THE DRAWINGS

FIG. 1 shows a typical installation on a vehicle (A) of an accessory for automating the turning off and on of full beam headlights in the presence of a vehicle that meets it. The figure shows a box (20) housing an analysis circuit (1) and boxes (21, 22) accommodating the control circuits (2) relevant to the right and left headlights.

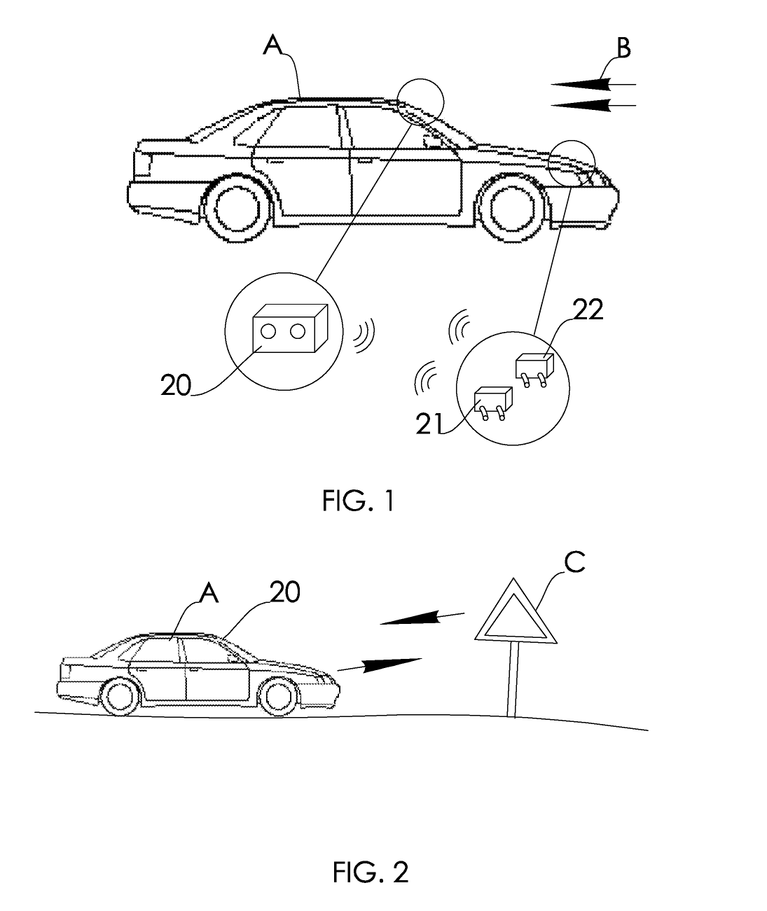

FIG. 2 shows an example of how can the objects surrounding the vehicle (A), and in particular the reflecting road sign (C), interfere with the operation of the analysis circuit located inside the box (20).

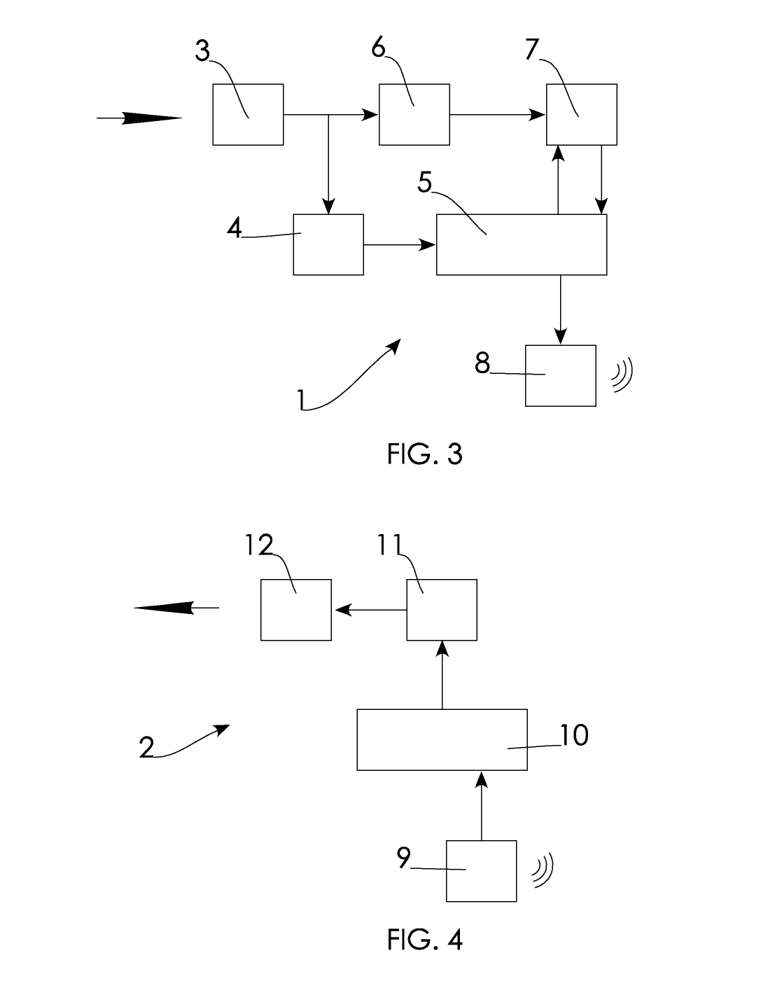

FIG. 3 shows a particularly compete embodiment of the analysis circuit (1) usually housed inside said box (20), in the case of a single photo-detector. The light beam, represented by an arrow, is incident on a photo-detector (3) which emits a signal which is processed by a decision circuit (4) and compared by a comparator (7). The figure also shows an equalizer filter (6), a microcontroller (5), and a wireless transmit assembly (8).

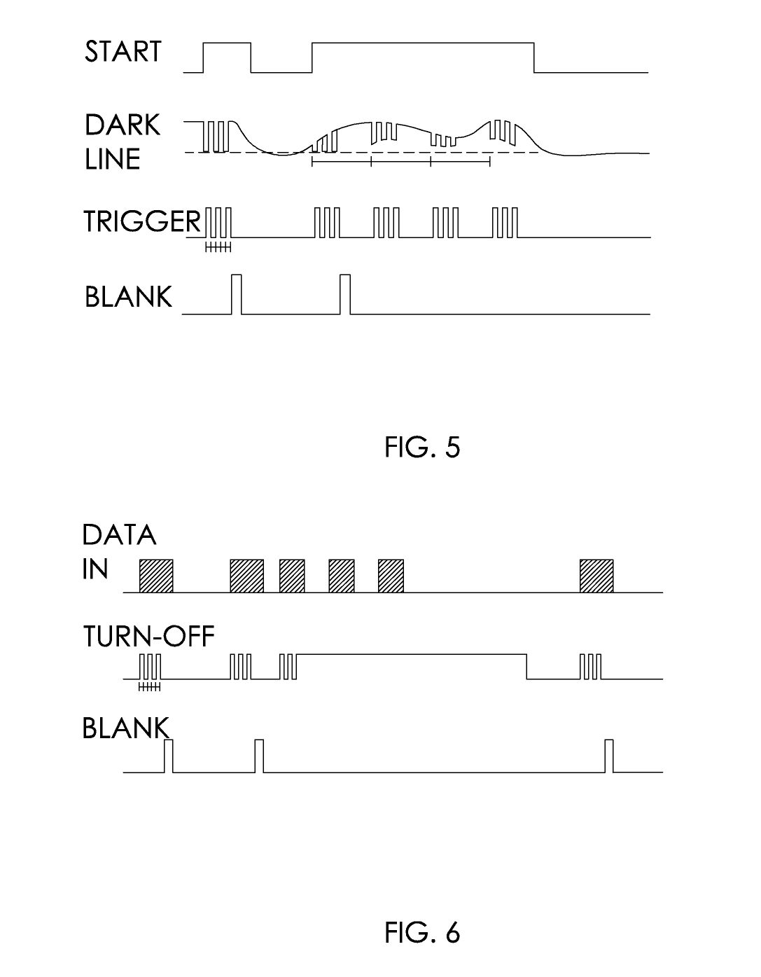

FIG. 4 shows the functional diagram of an embodiment of the control circuit (2) which is usually placed inside either of said boxes (21, 22). The figure also shows a wireless receive assembly (9), a microcontroller (10), a switch (11), and a full-beam headlight or shortly main beam (12) which emits a light beam represented by an arrow. The figure does not show the source used to supply power to the component elements, which is usually the 12 V or 24 V battery of the vehicle, nor other signals, including, for instance, that used by the driver to activate or deactivate the accessory manually. In a convenient embodiment, should the driver wish to bypass the operation of the accessory, appropriate signals can be sent via the power supply circuit.

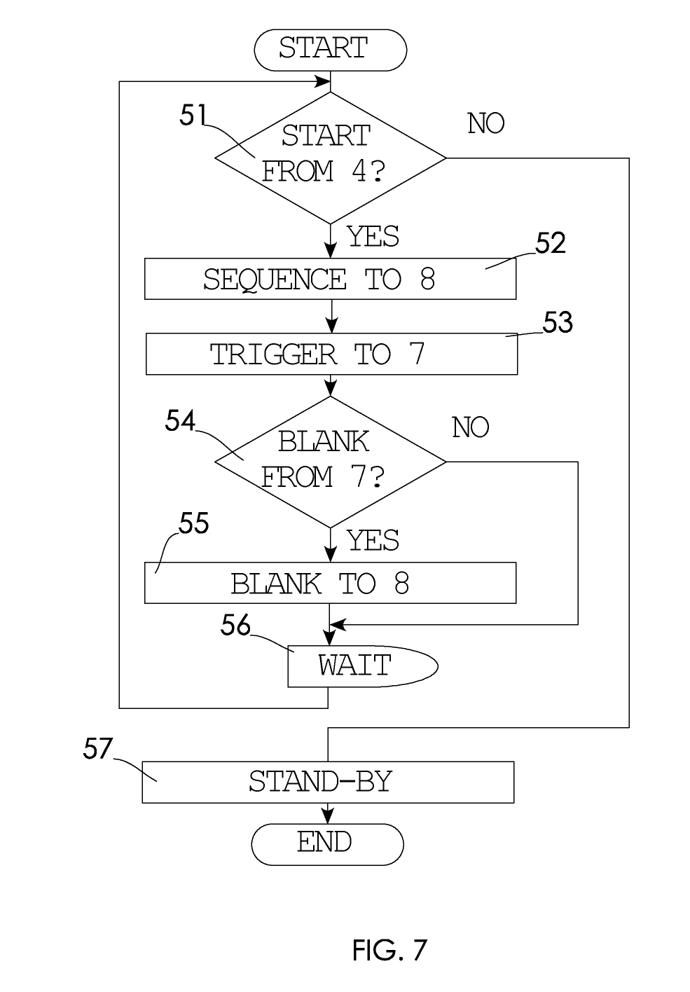

FIG. 5 shows the operation of the analysis circuit (1). In the first line there is the signal coming from the decision circuit (4), in the second line the signal from the photo-detector, also via an equalizer filter, in the third line the trigger signal whose sequence is determined by the microcontroller (5), and in the last line the outcome of the comparison carried out to check for the presence of a reflection possibly determined by surrounding objects. In the second line a horizontal line indicates the value for the relative dark condition.

FIG. 6 shows the operation of the control circuit (2). In the first line there is the signal input from the wireless receive assembly, in the second line the control signal sent to the switch, whereas the last line highlights the reflection cases which determine an extension of the transmission time, as apparent from a comparison to the first line. In the second line the main beams turn off as soon as the value is in the upper position.

FIG. 7 shows a flow chart of the operating logic of an embodiment of the microcontroller (5) of the analysis circuit which comprises the following operations:
(51) microcontroller operation triggered by the decision circuit (4);
(52) turn on and off sequence transmission control sent to the wireless transmit assembly (8);
(53) trigger signal sent to the threshold comparator (7);
(54) checking for the presence of a reflection or blank signal from the threshold comparator (7);
(55) blank signal sent to the threshold comparator;
(56) wait;
(57) stand-by.

FIG. 8 shows a flow chart of the operating logic of an embodiment of the microcontroller (10) of the control circuit which comprises the following operations:
(101) check for the presence of a turn on and off sequence start signal from the wireless receive assembly (9);
(102) sequence start command sent to the switch (11);
(103) check for the presence of a blank signal from the wireless receive assembly (9)
(104) 3 seconds wait, while the headlights are turned off;
(105) headlight turn on control signal sent to the switch (11).

FIG. 9 shows a functional diagram of a Schmitt comparator (12) which compares the signal from the photo-detector to the relative dark during the sequence set by the central processing unit.

FIG. 10 shows an embodiment of the analysis circuit (1) complete with a red sensor (32), i.e. with a photo-detector dedicated to the light emissions whose wavelengths range from 620 to 700 nm.

Installed upstream the red sensor (32) is an optical filter (31), whose function is to let the radiations corresponding to the red tone pass through while rejecting the others.

### DETAILED DESCRIPTION OF AN EMBODIMENT OF THE INVENTION

In a particularly complete and cost-effective embodiment that makes use of microcontrollers, the accessory with an electronic system for deleting disturbances according to the present patent application comprises two silicon photodiodes housed in a box (20) with two holes facing the same side. An optical concentration system is applied to either of these holes, whereas a filter is applied to the other. Said box (20) includes appropriate means for being secured to the inside of the windscreen of a vehicle or to another appropriate position.

The box accommodates inside an analysis circuit (1) which analyses the electrical signals produced by said two photodiodes, which comprises a decision circuit (4) which outputs a signal whenever such a light beam is incident on the photo-detectors so as to indicate the presence of another vehicle coming from the opposite direction.

The mode of use whereby two photodiodes are used instead of one detector is known in the present status of the art, for instance that described in ITFI20130072.

In the embodiment here described said analysis circuit also comprises a microcontroller (5) equipped with a transmit firmware resident in the indelible internal storage, and an equalizer filter (6) which suppresses the alternating component produced by the public lighting, which usually receives power from the 50 Hz or 60 Hz public distribution networks, and a threshold comparator (7).

Said analysis circuit (1) receives power from a battery which also supplies power to said one or several photo-detectors and to said transmit assembly.

The central processing unit of said microcontroller (5) performs the instructions stored in the transmit firmware and at least generates a signal output to a transmit assembly (8) and a signal output to said threshold comparator (7). The signal output from the latter is fed back as an input to the same microcontroller (5).

The signal output from the microcontroller (5) to the wireless transmit assembly (8) is sent to a wireless receive assembly (9) connected to a main beam turn off and on control circuit.

Said control circuit (2) comprises a microcontroller (10) equipped with a receive firmware resident in the indelible internal storage and an electronic switch which, in a preferred embodiment, is of the MOSFET type.

Both firmwares contain one and the same sequence which, in the case of the receive firmware, causes the headlights to turn on and off whereas, in the case of the transmit firmware, it determines the trigger signal that is sent to said comparator (7) by said microcontroller (5).

In other words, said comparator (7), which is a Schmitt trigger in a preferred embodiment, compares the signal from said photodiodes to a trigger signal that represents a synchronized dark signal, corresponding to the programmed main beam turn off and on sequence. Since the trigger signal sequence is equal to the main beam turn off and on sequence, said comparator (7) checks whether a light beam remains in the absence of the reflected light beam of the full beam read lights of its own vehicle.

If, the full beam headlights not being turned on, the photodiodes indicate the presence of a light beam, then it is assumed that this is produced by a vehicle that is going to be met, otherwise it is a matter of a reflection or blank due to a reflection onto surrounding objects.

So this condition is detected by the comparator which sends a reflection signal to the microcontroller which inserts it into the output signal addressed to said wireless transmit assembly (8) which sends it to the wireless receive assembly (9). Having been received by the microcontroller (10), the reflection signal causes the headlights to immediately turn on again. In the absence of a reflection signal, the receive microcontroller holds the turn off condition for a given period of time. The latter can vary from two seconds to five seconds and preferably equals three seconds.

The activation of the transmit microcontroller is controlled by said decision circuit (4), immediately upon detecting a condition whereby there is a risk of dazzling an incoming vehicle. This progressive activation of the different elements of the accessory results in an important energy saving which safeguards the battery used to supply power to the circuit contained in said box (20).

In a preferred embodiment the time sequence of the receive firmware features a turn off duration ranging from 10 to 100 ms alternating to equal turn on intervals. In the embodiment here described, both said turn off duration and said interval last 20 milliseconds.

Conveniently can the sequence include some repetitions of the turn off and on sequence so as to prevent inaccurate detections due to objects that determined a temporary darkening, be they external to or part of the vehicle. A preferred embodiment of said sequence features three turnings off.

Further, in order to limit the use of the device and its power consumption to those cases in which it is really needed, a pause is introduced between the start of a main beam turn off and on sequence and the next one.

Advantageously can this pause be provided after a reflection signal is sent, or not, by said microcontroller (5), before checking again whether the decision circuit (4) requests a new analysis cycle to be repeated.

Conversely, if no reflection signal has been produced, then the control circuit (2) keeps the main beams turned off for a given period of time, for instance three seconds.

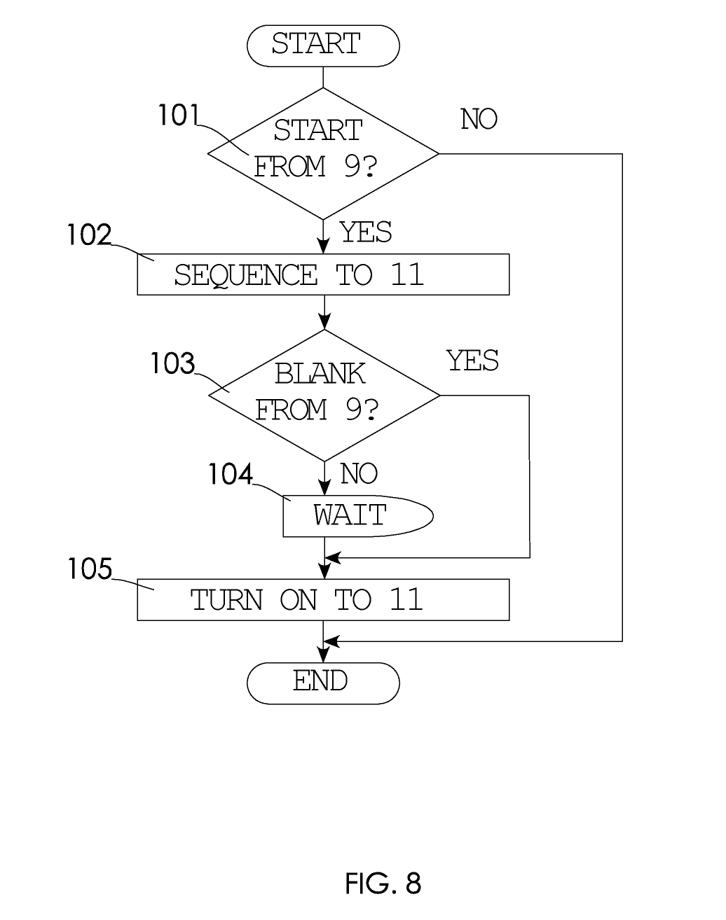

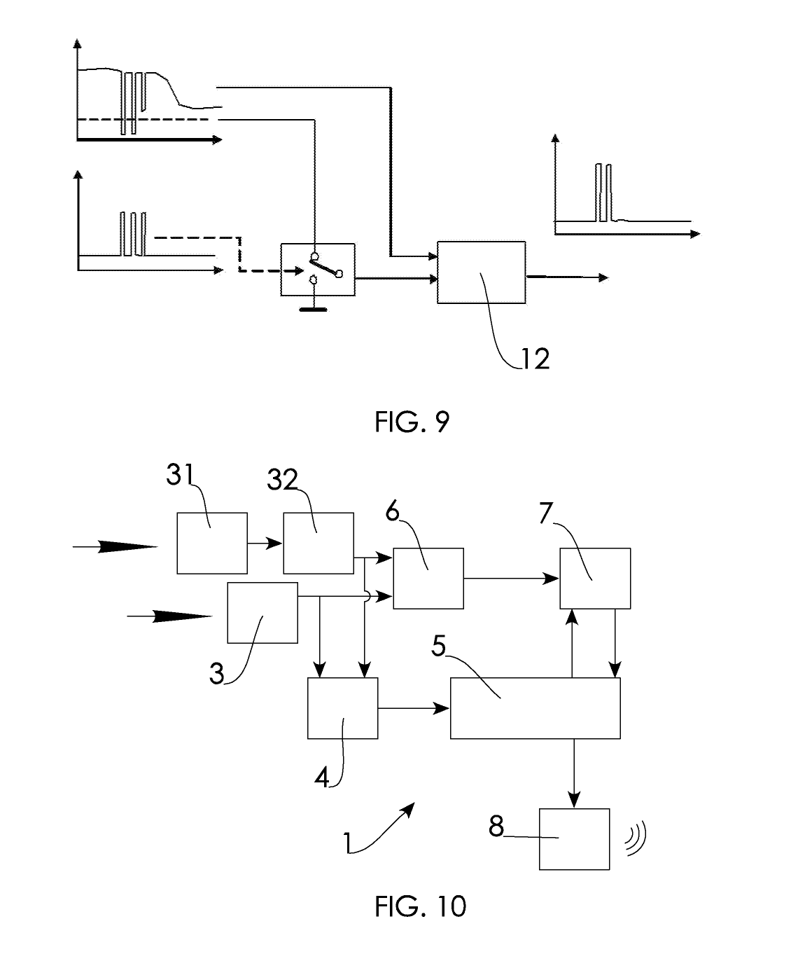

Reference is made to the description of FIGS. 5 and 6 for further details on the operation of the analysis and control circuits in a particular embodiment.

In a particularly complete embodiment of the invention a sensor (32), also called red sensor, dedicated to detecting the 660 nm±40 nm spectrum, corresponding to the red color, is also equipped; an optical filter (31) installed upstream the red sensor operates in such a way as to let the radiations corresponding to the red color only pass through, while rejecting the others, present in the artificial light sources, thus enhancing the selective sensitivity of the red sensor.

The signal detected by the red sensor is sent to the decision circuit together with the signal detected by the main light sensor, hence both sensors are in a position to activate, independently of each other, the start of the transmission procedure to the receive assembly which in turn drives the main beams electronic switches.

1-12. (canceled)

13. An accessory for vehicles to automate the turn-off and the turn-on of the main beams, comprising:
one or several photo-detectors;
a main beam turn-off and turn-on control circuit comprising a central processing unit which runs a program stored in a memory and controls a switch which makes said main beams turn on or off;
an analysis circuit analyzing electrical signals generated by said one or several photo-detectors comprising a decision circuit, a central processing unit which runs a program stored in a memory, and a comparator which compares the signal coming from said one or several photo-detectors to a trigger signal, corresponding to the relative dark signal, generated by said central processing unit;
a wireless transmit assembly connected to said analysis circuit which transmits the signal received by it;
a wireless receive assembly, connected to said control circuit, which receives the signal from said wireless transmit assembly; and
a battery which supplies power to said one or several photo-detectors, to said analysis circuit and to said transmit assembly;
wherein said program of said main beam turn-off and turn-on control circuit and said program of said analysis circuit share a timing sequence, whose execution is coordinated via said wireless transmit assembly and said wireless receive assembly, so that the sequence of said trigger signal is synchronous with the main beam turn-on and turn-off sequence; wherein said comparator outputs a reflection or blank signal toward said central processing unit of said analysis circuit whenever the magnitude of said signal from said one or several photo-detectors is greater than the magnitude of said trigger signal; wherein in the presence of said reflection or blank signal, said central processing unit of said analysis circuit sends to said main beam turn-off and turn-on control circuit a reflection or blank signal and therefore causing the main beams to be turned-on again.

14. The accessory according to claim 13, wherein said program of said main beam turn-off and turn-on control circuit and said program of said analysis circuit start being run under the control of said decision circuit which activates said central processing unit of said analysis circuit which in turn starts the transmission of said wireless transmit assembly.

15. The accessory according to claim 14, wherein said timing sequence makes said main beam turn-off and turn-on control circuit turn-off said main beams at least two times.

16. The accessory according to claim 15, wherein said program of said main beam turn-off and turn-on control circuit and said program of said analysis circuit start being run thereafter in the presence of said signal sent by said decision circuit after a pre-determined delay time.

17. The accessory according to claim 16, wherein said pre-determined delay time is one second.

18. The accessory according to claim 15, wherein said main beam turn-off and turn-on control circuit, in the absence of said reflection or blank signal, makes the main beams turn-on again after three seconds.

19. The accessory according to claim 14, wherein said main beam turn-off and turn-on control circuit, in the absence of said reflection or blank signal, makes the main beams turn-on again after three seconds.

20. The accessory according to claim 14, wherein said program of said main beam turn-off and turn-on control circuit and said program of said analysis circuit start being run thereafter in the presence of said signal sent by said decision circuit after a pre-determined delay time.

21. The accessory according to claim 20, wherein said pre-determined delay time is one second.

22. The accessory according to claim 20, wherein said main beam turn-off and turn-on control circuit, in the absence of said reflection or blank signal, makes the main beams turn-on again after three seconds.

23. The accessory according to claim 13, wherein one of said one or several photo-detectors is dedicated to detecting all or some of the light emissions comprised in the range of the wavelengths from 620 to 700 nm.

24. The accessory according to claim 23, wherein upstream said photo-detector dedicated to all or some of the light emissions comprised in the range of the wavelengths from 620 to 700 nm there is installed a filter of a type that lets at least some of the light emissions comprised in the range of the wavelengths from 620 to 700 pass through.

25. The accessory according to claim 24, wherein said filter is an optical filter.

26. The accessory according to claim 13, wherein said timing sequence makes said main beam turn-off and turn-on control circuit turn-off said main beams at least two times.

27. The accessory according to claim 13, wherein said program of said main beam turn-off and turn-on control circuit and said program of said analysis circuit start being run thereafter in the presence of said signal sent by said decision circuit after a pre-determined delay time.

28. The accessory according to claim 27, wherein said pre-determined delay time is one second.

29. The accessory according to claim 13, wherein said analysis circuit comprises an equalizer filter which suppresses one or several frequency components of the signal coming from said one or several photo-detectors before it is input to said comparator.

30. The accessory according to claim 13, wherein said central processing unit and said program memory of said analysis circuit are contained in a microcontroller.

31. The accessory according to claim 13, wherein said processing unit and said program memory of said main beam turn-off and turn-on control circuit are contained in a microcontroller.

32. The accessory according to claim 13, wherein said main beam turn-off and turn-on control circuit, in the absence of said reflection or blank signal, makes the main beams turn-on again after three seconds.
